(19) United States
(12) Patent Application Publication
(10) Pub. No.: US 2026/0065681 A1
(43) Pub. Date: Mar. 5, 2026

(54) SYSTEM AND METHOD FOR IMAGE-BASED AIR POLLUTION MONITORING

(71) Applicant: Nuvis Technologies Inc., Mississauga (CA)

(72) Inventors: Anton Goma Huguet, Cervera (ES); Damodar Arapakota, Mississauga (CA)

(73) Assignee: Nuvis Technologies Inc., Mississauga (CA)

(21) Appl. No.: 19/315,533

(22) Filed: Aug. 30, 2025

Related U.S. Application Data
(60) Provisional application No. 63/688,916, filed on Aug. 30, 2024.

(51) Int. Cl. G06V 20/52; G06T 7/00; G06V 10/20; G06V 10/70; G06V 10/774

(52) U.S. Cl. CPC G06V 20/52; G06T 7/0002; G06V 10/20; G06V 10/70; G06V 10/774; G06T 2207/10032; G06T 2207/20081; G06T 2207/30181

(57) ABSTRACT

Systems and methods are disclosed for image-based monitoring of air pollution using a trained artificial-intelligence (AI) model. An image capturing unit acquires images of a field of view in at least one spectral band. The captured images are synchronized in time and location with reference measurements (e.g., from ground sensors, satellite products, or meteorological instruments) to form training dataset for the AI model. In operation, the trained AI model processes captured images to determine a pollutant concentration distribution map across the field of view and can identify emission sources by detecting spatial extrema. The system supports single or multiple cameras, including fixed, movable, or drone-mounted platforms, and may incorporate multi-band image fusion. After training, inference may be performed from images alone without real-time reference sensors. Outputs include heatmap visualizations, concentration values for gaseous species and particulate matter, alerts, and trend analyses.

### BACKGROUND

The embodiments herein are generally related to environmental monitoring technologies. The embodiments herein are particularly related to automated air pollution monitoring. The embodiments herein are more particularly related to a system and method for image-based air pollution monitoring.

Conventional air quality monitoring techniques primarily rely on physical sampling methods and sensor-based systems that measure concentrations of pollutants at specific locations. These systems often involve complex infrastructures, including numerous ground stations that can be expensive to maintain and challenging to deploy in remote or inaccessible areas. Additionally, traditional methods typically provide delayed results due to the need for manual sample analysis and are limited in spatial coverage, which may not effectively represent large-scale or dynamic changes in air quality.

For instance, in satellite air quality monitoring, which is based on low orbit satellites, measures of pollution levels are taken at specific spots on the Earth in a discontinued manner. The few measures per day for the results of a satellite system constellation, which are available only 24 hours later.

Traditional methods of monitoring air quality primarily rely on Air Quality Index (AQI) measurements, which are based on the concentrations of major pollutants detected by ground-based monitoring stations. These stations are equipped with various sensors that measure pollutants like particulate matter and other gases. The data collected are processed to generate an AQI value, which provides a numerical scale to help the public understand the air quality in a particular area. While effective for general assessments, this method depends heavily on the availability and correct functioning of monitoring stations, which are often sparse and can be costly to maintain and operate.

Therefore, there exists a need for a system and method for image-based air pollution monitoring that provides broader spatial coverage and real-time data on air quality by leveraging advancements in imaging technology and artificial intelligence, and enabling comprehensive and instantaneous analysis of air pollution across varied environments.

The abovementioned shortcomings, disadvantages and problems are addressed herein, which will be understood by reading and studying the following specification.

The primary object of the embodiments herein is to provide a system and method image-based air pollution monitoring.

Another object of the embodiments herein is to utilize AI to analyze images for detecting and quantifying air pollutants accurately.

Yet another object of the embodiments herein is to reduce the infrastructural and operational costs associated with traditional air quality monitoring systems.

Yet another object of the embodiments herein is to provide enhanced spatial coverage and the ability to monitor air quality over large areas.

Yet another object of the embodiments herein is to enable the integration of a plurality of data sources for creating datasets for further data processing and data training purposes, including creation of new automation and Artificial Intelligence models.

Yet another object of the embodiments herein is to provide a system that is adaptable to various environmental conditions and different types of pollutants

Yet another object of the embodiments herein is to facilitate the rapid deployment of air quality monitoring in remote or inaccessible locations.

Yet another object of the embodiments herein is to improve the responsiveness of air quality monitoring systems to environmental changes and events.

Yet another object of the embodiments herein is to enable governmental and environmental agencies to make informed decisions based on comprehensive real-time data.

Yet another object of the embodiments herein is to support public health and environmental protection initiatives through improved air quality monitoring.

These and other objects and advantages of the embodiments herein will become readily apparent from the following detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings.

The various embodiments herein provide a system and method for image-based air pollution monitoring.

According to one embodiment herein, the present disclosure discloses a system for image-based air pollution monitoring. The system comprises: system for image-based air pollution monitoring, the system comprising: an image capturing unit, wherein the image capturing unit captures one or more images of a field of view in one or more spectral bands; and a processing unit communicatively coupled to the image capturing unit, further wherein: the processing unit comprises one or more processors and a memory storing a trained artificial intelligence (AI) model, the processing unit determines, based on the captured images and using the trained AI model, a pollutant concentration distribution map of the field of view.

According to an embodiment, image capturing unit continuously gathers visual data from the environment, capturing dynamic changes in air quality using a plurality of high-resolution imaging modules capable of capturing images primarily in the visible spectrum, with other spectral bands (such as ultraviolet or near-infrared); Reference sensor module providing reference measurements that serve as essential contextual information enabling accurate analysis of environmental conditions that influence pollutant dispersion and concentration, using a plurality of meteorological sensors measuring environmental parameters including temperature, humidity, wind speed, and atmospheric pressure; Data integration and pre-processing module integrating data from the image capturing unit and reference sensors module for and carrying out pre-processing of the data for further analysis; AI Module predicting air pollution level based on the pre-processed imaging and reference data using specific and contextual pre-trained models, and adapting the model to the local environmental conditions and pollutant patterns by refining the model based on the new data; Data storage module storing all the collected and processed data including imaging data, reference data and historical air quality data enabling long-term data analysis, and archival for compliance and reporting purposes; Data visualization and reporting module transforming the analysed data into a plurality of graphical representations, charts and detailed reports, eliciting trends and providing insights from complex datasets; User Interface module providing interactive interface for users to access real-time data, historical analysis, and system settings enabling easy navigation, customization, and control over system functions, for using the system to monitor air pollution; Communications module providing reliable and secure data flow within the system and facilitates integration with external systems, making the data accessible for further analysis or emergency response coordination; and cloud back-end providing computing power and storage over cloud, facilitating large-scale data processing, enabling scalability and flexibility in data handling, allowing for robust data management, enhanced computational resources for AI processing, and ensuring data integrity and security across distributed environments. The image capturing unit further comprising a plurality of imaging modules including an optical imaging module supplemented by other spectrum imaging modules namely, a UV imaging module and a NIR imaging module for additional spectral input. The reference sensor module comprises a plurality of meteorological sensors measuring environmental parameters including temperature, humidity, wind speed, and atmospheric pressure, providing essential contextual information for accurate analysis of environmental conditions that influence pollutant dispersion and concentration. The AI module performs real-time analysis and prediction of pollution levels based on the integrated data set using pre-trained model and wherein the AI module further comprises a dynamic adaptation module that continuously updates and refines the AI model based on incoming real-time data flow, ensuring the model evolves in response to new environmental patterns and data insights.

According to one embodiment herein, the present disclosure discloses a method for image-based air pollution monitoring. The method comprises: capturing one or more images of a field of view in one or more spectral bands; and determining, based on the captured images and using a trained artificial intelligence (AI) model, a pollutant concentration distribution map of the field of view.

In an embodiment, the method for image-based air pollution monitoring comprises: configuring the operational parameters wherein the operational parameters include system's operational boundaries, geographic areas to be monitored, specific pollutants to track, and the frequency and spectrum of image to be captured; capturing images using one or more cameras primarily in the visible spectrum (VIS), optionally complemented by other spectral imaging (such as UV or NIR); capturing real-time reference data from a plurality of meteorological sensors including temperature, humidity, and other meteorological factors; integrating and pre-processing the image and reference data wherein the captured images and real-time reference data from a plurality of sensors are integrated and pre-processed by normalizing and cleaning the data to ensure suitability for accurate analysis; carrying out real-time analysis using pre-trained AI model and predicting pollutant levels based on the integrated dataset; refining model with the real-time data enabling the model to stay accurate and responsive to changing environmental conditions and emerging pollution patterns; visualization and reporting the in user-friendly formats such as graphs, charts, and maps, and generating reports with insights and actionable information to stakeholder; and system monitoring and maintenance ensuring high performance and reliability of the monitoring system by a plurality of measures including hardware checks, software updates, and calibration of sensors and cameras, maintaining.

According to one embodiment herein, a method for image-based air pollution monitoring, comprising: capturing one or more images of a field of view in one or more spectral bands; and determining, based on the captured images and using a trained artificial intelligence (AI) model, a pollutant concentration distribution map of the field of view.

According to one embodiment herein, a method is provided for generating pre-trained model for image-based air pollution monitoring. The method comprises: data collection for pre-training wherein a diverse set of data, including environmental images and associated metadata including pollutant concentrations and meteorological conditions are collected from reference datasets for building a comprehensive dataset that reflects various environmental scenarios and pollution levels; data pre-processing wherein the data undergoes rigorous preprocessing to ensure its quality and consistency wherein the data pre-processing includes cleaning the data, handling missing values, normalizing measurements, enhancing image quality, and preparing the dataset for effective feature extraction and machine learning analysis; feature engineering wherein the significant features are extracted from the preprocessed data to identify and isolate relevant features from the images and sensor data indicative of pollution levels by focusing on the most informative attributes; selecting appropriate ML model based on the nature of the data and the specific requirements of the system ensuring the model aligns with the data characteristics and prediction goals; training the model using the prepared dataset, optimizing performance through techniques including cross-validation, and continually assessing the model's accuracy to ensure it learns effectively from the training data; model validation and testing against a separate set of data that was not used during training, evaluating the model's generalizability and effectiveness in predicting unseen data, ensuring it performs reliably under various conditions; refining the model based on the outcomes of the validation phase, by re-tuning parameters, retraining parts of the model, or revisiting feature selection to address any deficiencies identified during testing; and deploying the model within the air pollution monitoring system and providing real-time predictions and insights, actively contributing to the monitoring and management of air quality.

According to an embodiment, the present disclosure discloses a non-transitory computer-readable medium storing instructions that, when executed by one or more processors, cause the processors to: capture one or more images of a field of view in one or more spectral bands; determine, based on the captured images and using a trained artificial intelligence (AI) model, a pollutant concentration distribution map of the field of view.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates the overall architecture of the system for image-based air pollution monitoring, according to one embodiment herein.

FIG. 2 illustrates a method for image-based air pollution monitoring, according to one embodiment herein.

FIG. 3 illustrates a method for generating pre-trained models for image-based air pollution monitoring, according to one embodiment herein.

FIG. 4 illustrates a system for generating pollutant concentration distribution map for image-based air pollution monitoring, according to one embodiment herein.

FIG. 5 illustrates a general block diagram of the system, according to an embodiment herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

The various embodiments herein provide a system and method for image-based air pollution monitoring offering several distinct advantages over conventional techniques. Enabling the monitoring of a much broader geographic area compared to stationary ground sensors, this comprehensive coverage is crucial for accurately assessing air quality in large urban sprawls, remote regions, and varying landscapes overcoming the physical constraints. The system processes and analyzes images in real time allowing immediate identification and reporting of changes in air quality, offering timely information that is critical for public health advisories. The image-based approach minimizes the need for expensive sensor networks and the logistical challenges of maintaining them in diverse environmental conditions. The system's ability to detect subtle changes in the environment through advanced image analysis (focusing on visible-light imaging, with other spectral data used optionally for calibration) enhances its sensitivity to various pollutants. The system is configured for scalability and modifications to include new types of pollutants or to be deployed in different regions, adapting to specific local needs and capabilities.

According to an embodiment, the system for image-based air pollution monitoring comprises an image capturing unit and a processing unit configured to analyze the captured images. The image capturing unit includes one or more cameras that acquire images of a field of view in one or more spectral bands, such as ultraviolet (UV), visible, or near-infrared (NIR) wavelengths. The cameras may be deployed in a fixed position (for example, mounted on a pole or building overlooking an area of interest) or may be movable, including implementations on vehicles or mounted on drones or other aerial platforms. In operation, the cameras capture scenes of the environment that potentially contain pollutant plumes or other visual indicators of air quality. By using appropriate spectral sensitivity (for instance, UV imaging to detect pollutants that absorb UV light, or IR imaging for gases visible in infrared), the image capturing unit gathers raw visual data that is rich in information about the air within the field of view. Each image is time-stamped and optionally geo-tagged, providing context for alignment with other data sources. The flexibility of the imaging capturing unit allows it to operate under various conditions, for example, a drone-mounted camera can survey different locations or track plumes from multiple angles, while a fixed camera can continuously monitor a particular site. In some embodiments, multiple cameras are used simultaneously, either to cover different spectral bands or to observe the area from different viewpoints.

According to an embodiment, a processing unit incorporates a trained artificial intelligence (AI) model that is configured to determine a pollutant concentration distribution map for the scene captured in each image. During deployment (i.e., real-world use of the system after training is completed), the AI model operates on image data alone to infer the concentrations of one or more pollutants across the field of view. In other words, once the model is trained, it does not require additional physical sensors or instruments to measure pollutants in real-time. The trained AI model is typically a machine learning model (for example, a deep neural network or an ensemble of algorithms) that has learned to correlate specific image features or patterns with pollution levels. As the processing unit receives an input image, it feeds the image (or a set of images, if multiple spectral channels are used) into the AI model, which then outputs a corresponding distribution map of pollutant concentration. This distribution map is a representation (for instance, a two-dimensional array of values) indicating the estimated concentration of the target pollutant(s) at various locations within the image's field of view. Each location in the map corresponds to a portion of the scene, for example, each pixel or defined cell area in the image can be assigned a pollutant concentration value. The result is essentially a spatially resolved depiction of how pollutant concentration varies across the observed area, generated solely from analyzing the visual data. The processing unit can update this map as frequently as new images arrive, allowing the system to produce a continuous stream of pollutant concentration data over time.

According to an embodiment, to create and calibrate the AI model, the system is trained using reference measurements obtained from external sensors and measurement sources during a training phase (which may occur prior to deployment or as an ongoing calibration routine). The external/reference sensors provide ground-truth pollutant measurements that correspond to what the cameras are seeing, and they ensure the AI model's outputs are anchored to real pollutant concentration values. Various types of reference sensors can be used, including but not limited to ground-based gas analyzers, electrochemical sensor units, meteorological sensing instruments, and even satellite-based remote sensing data. For example, ground-based analyzers might measure specific pollutants (such as NO₂, SO₂, ozone, or particulate concentrations) at fixed stations around the monitored area, providing accurate concentration readings at those points. Electrochemical sensors could be deployed in the field of view of the cameras (e.g., placed on the ground or on structures within the scene) to measure pollutant levels in real time. Meteorological sensors can record environmental conditions (like wind speed, wind direction, temperature, humidity, and solar irradiance) that are relevant for both pollutant dispersion and for the optical characteristics of the scene; such data can be useful in training or in refining the AI model's predictions under different weather conditions. Additionally, satellite-based sources or other remote sensing data can serve as reference information especially for large-scale or cloud cover conditions, by providing an independent measure of pollutant presence over broad areas. The reference measurements are collected in synchronization with the images captured by the system's cameras to form a training dataset. Synchronization in this context means that for a given image (or set of images) captured by the camera at a particular time and view, the system obtains the corresponding pollutant concentration measurements from the reference sensors that describe the actual air quality in that scene at that same time. This may involve timestamp alignment and spatial alignment.

According to an embodiment, the captured images and synchronized reference measurements are used together to train an AI model through machine learning techniques. During training, each image (or set of multi-spectral images captured at the same moment) is input to the AI model, and the corresponding reference measurement(s) serve as the target output that the model should learn to predict. In practice, training could involve supervised learning where the model gradually adjusts its internal parameters (weights) to minimize the difference between its predicted pollutant concentrations (based on the image features) and the known concentrations from the reference sensors. The training data can cover a wide range of scenarios, pollutant levels, and environmental conditions to ensure the model becomes robust. For example, the dataset may include images taken under different lighting conditions (bright sun, overcast, night with artificial lighting), various weather conditions (clear days, hazy days, high humidity or fog, etc.), and different pollutant scenarios (low concentrations as well as high-concentration plumes) along with their corresponding sensor measurements. The reference measurements might be a single value representing an average pollutant level in the scene, or a set of multiple values representing spatial distribution (if multiple sensors are used across the field of view).

According to an embodiment, once the AI model is trained and validated, it can be deployed as part of the processing unit. The system is designed to be adaptable, allowing the model to be retrained or updated to expand its capabilities or improve its accuracy. In particular, the system supports updating the AI model to handle additional types of pollutants by retraining with new data. For example, the initial training phase might focus on a certain pollutant (or a set of pollutants) for which reference data was available, such as training the model to detect fine particulate matter (PM_{2.5}/PM₁₀) based on image haze. Later, if it becomes desirable to monitor a different pollutant (say, nitrogen dioxide or ammonia) in the same manner, the system can be provided with additional training data that includes images along with reference measurements for the new pollutant. The AI model can then be retrained on this augmented dataset, thereby learning the visual indicators of the new pollutant while retaining knowledge of previously learned ones. Further, the system could periodically retrain the model with recent data to account for any long-term changes in environmental conditions or imaging characteristics, thereby maintaining accuracy over time.

According to an embodiment, the processing unit uses the trained AI model to generate a pollutant concentration distribution map from each image. The distribution map is produced for the field of view captured by the camera and provides a spatial layout of pollutant concentrations across that scene. In practice, the processing unit runs the input image through the AI model's inference process and obtains output data that can be structured as a two-dimensional grid aligned with the image coordinates. Each grid cell or pixel in this output corresponds to a specific portion of the scene and contains a value representing the estimated concentration of the pollutant at that location. The AI model inherently accounts for various visual cues, for instance, certain color casts in the image might indicate the presence of NOx gases, or the level of scene haziness might correlate with particulate concentration, and integrates them in a learned way to output quantitative concentration estimates. The distribution map data can be stored in memory and also passed to other sub-modules of the system for further action, such as visualization, alerting, or trend analysis. Because the system generates these maps based on learned correlations, it can function even in scenarios where the pollutant is not directly visible to the human eye (for example, an infrared-sensitive model might detect CO₂ plumes that are invisible in the visible spectrum).

According to an embodiment, the image-based AI monitoring approach can be adapted to detect and measure a wide variety of air contaminants. The pollutants that the system can handle include, for example, sulfur oxides (SOₓ) such as sulfur dioxide (SO₂), nitrogen oxides (NOx) such as nitrogen dioxide (NO₂), ozone (O₃), carbon monoxide (CO), carbon dioxide (CO₂), volatile organic compounds (VOCs), hydrogen sulfide (H₂S), ammonia (NH₃), and particulate matter (PM) (which encompasses airborne particulates of various sizes, like PM₁₀ or PM_{2.5}). By selecting appropriate spectral imaging bands and training the AI model with reference data for each pollutant, the system can learn these visual signatures and quantify the pollutant's concentration. The system is not inherently limited to the examples listed, essentially any pollutant that has some effect on how light propagates through air or on how objects appear in an image can potentially be monitored. The design of the AI model and training process is general enough that, given training images and corresponding sensor measurements for a new target pollutant, the model can be taught to recognize that pollutant. In multi-pollutant scenarios, the model can either be a single network with multiple outputs (one per pollutant) or a collection of models each focusing on one pollutant; either way, the system can concurrently generate multiple pollutant distribution maps if needed. Thus, the system provides a versatile platform for air quality monitoring, applicable to many contaminants of interest, using image-based inference.

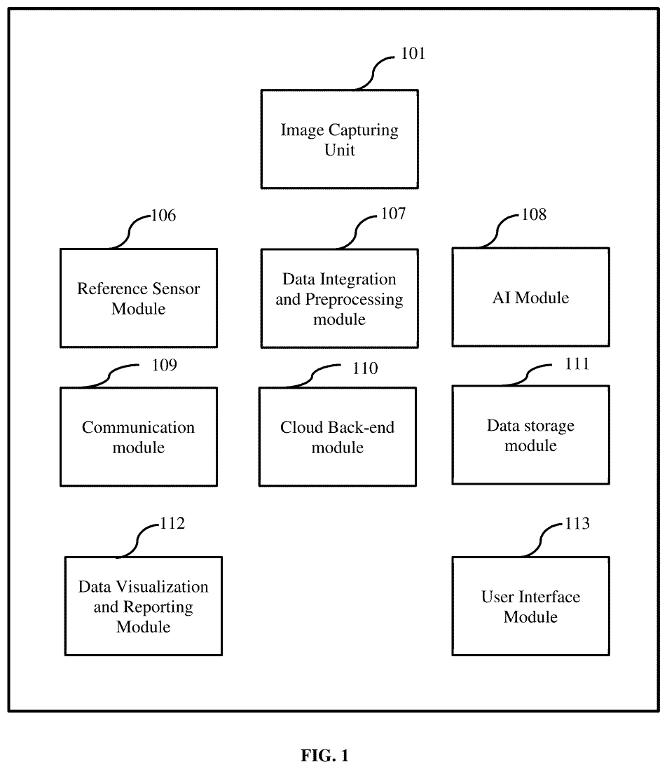

A detailed explanation of each of the above-mentioned operations will be explained in the forthcoming paragraphs through FIGS. 1-5.

FIG. 1 illustrates the overall architecture of the system image-based air pollution monitoring, according to one embodiment herein. The system comprises Image Capturing Unit 101. The image capturing unit 101 acquires high-resolution images in at least one spectral band allowing the system to detect various pollutants that have unique spectral signatures. For instance, certain gaseous pollutants like sulfur dioxide or nitrogen dioxide absorb UV light and are more discernible in ultraviolet images, whereas particulate matter causes haze in visible-spectrum images and can be observed via optical scattering. The multiple imaging modules operate concurrently, providing a composite view of the air quality in the field of view. In certain embodiments, multiple imaging modules (e.g., visible (VIS), ultraviolet (UV), and near-infrared (NIR)) may concurrently acquire images of a common field of view and provide those images to an AI model. However, concurrent multi-band imaging is not required. The system is configured to estimate concentrations of pollutants including gases whose strongest absorption features lie outside the visible spectrum, such as in UV or NIR using images acquired solely in the visible spectrum. Although such pollutants may not be directly discernible to a human observer in a visible image, their presence can alter the scene's visible appearance (e.g., via scattering, contrast, color balance, haze, and brightness effects). The AI model is trained to learn these correlations using training data composed of time-and location-synchronized pairs of images and corresponding reference measurements. Following such training, the model can infer pollutant concentration distribution maps from visible images alone, while remaining capable of incorporating additional spectral channels when available.

In an embodiment, the system includes a Reference Sensor Module 106 that continuously collects auxiliary environmental data from the same monitored area. The module 106 includes various meteorological sensors (such as temperature, humidity, atmospheric pressure, wind speed, and wind direction sensors) and can also incorporate pollutant-specific sensors (for example, electrochemical gas sensors or particulate counters) or even data feeds from external sources like satellite-based air quality sensors. The environmental measurements provide essential context such as weather conditions and baseline pollutant levels that influence pollutant dispersion and concentration. By obtaining reference measurements that are synchronized in time and location with the captured images, the reference sensor module 106 ensures that the system has the necessary contextual information to interpret the image data accurately.

In an embodiment, the data from the image capturing unit 101 and the reference sensor module 106 is fed into a data integration and preprocessing module 107. The module 107 performs operations such as timestamp synchronization of images with reference measurements obtained from reference sensors, geometric alignment of images from different spectral cameras, noise reduction, brightness normalization across images, and correction for conditions like haze or camera motion.

In an embodiment, a Trained AI Module 108 (for example, a deep convolutional neural network or another machine learning model) infers air pollutant levels. The AI model has typically been pre-trained on a large dataset of images with known pollutant concentrations, so it can recognize patterns and features in the spectral images that correlate with the presence and amount of pollutants.

In an embodiment, the system includes a Communications Module 109, which manages data exchange between the on-site components and external systems or networks. The communications module 109 ensures reliable and secure transmission of data and commands.

In an embodiment, the system includes a Cloud Back-end Module 110 represents that provides scalable computing power and data storage capabilities that go beyond what an edge device or single camera unit can handle. The cloud back-end 110 also serves as a central repository for long-term data aggregation: it can store large volumes of historical image data, sensor logs, and analysis results. This cloud component ensures that the system can scale to cover wide geographic areas and large datasets, and it facilitates collaboration and data sharing (multiple stakeholders can access the cloud-stored results securely from different locations). The communications module 109 and cloud back-end 110 together make it possible for the system to function in distributed environments and to leverage internet connectivity for remote monitoring and control.

In an embodiment, the system includes a Data Storage Module 111 to archive collected data and intermediate results By maintaining this data storage 111, the system supports longitudinal studies of air quality (e.g., tracking pollution trends over months or years), compliance reporting (keeping records of when and where pollutant levels exceeded regulatory thresholds), and the retraining or validation of AI models with new data. The storage may be implemented as a database or file repository, and it works in conjunction with the cloud back-end 110 to ensure data integrity and redundancy (important data can be backed up to cloud servers for safety).

In an embodiment, the system includes a Data Visualization and Reporting Module 112 that converts the AI module's analytical results into user-friendly visual formats and reports. Module 112 can generate graphical representations such as heatmaps overlaying pollutant concentrations on a map or camera view, time-series charts showing pollutant level trends, and summary reports highlighting key findings (for example, daily peak pollution times or the identification of emission hotspots).

In an embodiment, the system provides an interactive User Interface Module 113 which allows human operators and end-users to engage with the monitoring system. The user interface 113 may be a software dashboard accessible via a computer or mobile device, or a physical control panel, depending on the implementation.

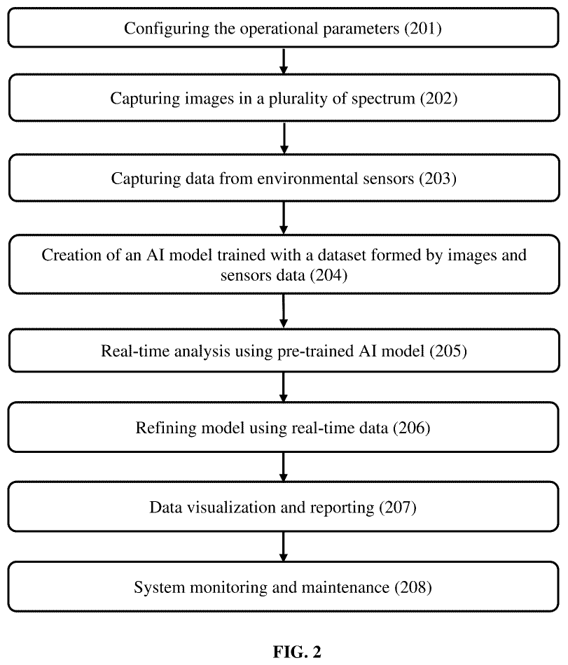

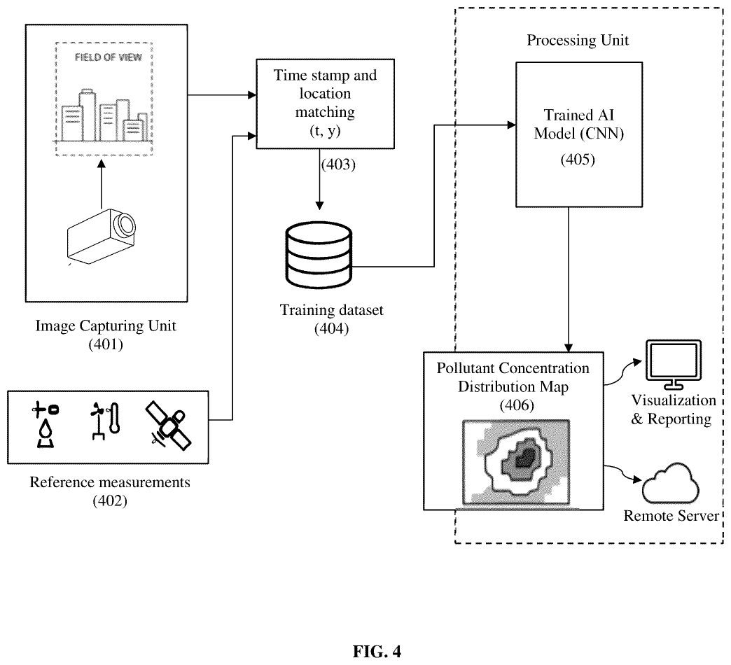

FIG. 2 illustrates a method for image-based air pollution monitoring, according to one embodiment herein. In step 201, the system is initialized with parameters for a monitoring session: for example, defining the geographic area to be monitored, selecting which pollutants are of interest, calibrating the system's sensors and cameras, and scheduling the frequency and timing of image capture. Operational parameters can also include setting threshold values for alerts (such as a maximum acceptable concentration for a pollutant before an alarm is triggered) and inputting any necessary calibration data (like baseline calibration images or sensor offsets). In step 202, the image capturing unit acquires images of the environment in the selected spectral bands. The system can use one or multiple cameras for this task. In many deployments, multiple cameras may be positioned at different vantage points to cover a wide area or different angles of the same area, for example, several cameras on various rooftops across a city, all capturing the skyline to detect smog layers. Simultaneously, step 203 is carried out, the system collects readings from environmental sensors. The sensor data includes meteorological parameters and can also include pollutant concentration measurements from ground-based detectors. Step 203 ensures that for every image (or set of images) captured in step 202, there is corresponding contextual sensor information. In this context, step 204 can involve either training a new AI model or loading a pre-trained model and updating it, using the incoming dataset. Essentially, the multi-spectral images and corresponding sensor measurements (which have been paired by time and location) form a training dataset that the system can use to calibrate its AI for local conditions. If an AI model has not been established yet, the system will train one at this stage: it learns the relationship between the visual features in the images and the ground-truth pollutant levels indicated by the sensor data. If a model was already pre-trained (for example, on a generic or global dataset), step 204 may refine this model using the new data, adapting it specifically to the deployment environment. The outcome of step 204 is a trained AI model ready to analyze current and future images. After the calibration of the AI model, the system is equipped to estimate pollutant levels from images even without always needing simultaneous sensor readings. In step 205, the system applies the trained AI model from step 204 to the incoming stream of new images (captured in step 202) to determine the presence and concentration of pollutants in real time. For each new image or set of images, the AI model processes the visual data, for instance, examining color intensity in the UV spectrum or patterns in the infrared, and produces an output such as a pollutant concentration distribution map for that field of view (as will be described in FIG. 4). In step 206, feedback from the system's ongoing operation is used to improve the AI model's accuracy and adaptability. This can occur in various ways: the system might periodically retrain the model with the latest batch of images and any new sensor measurements to correct any drift in the model's predictions, or it might use techniques like online learning where the model parameters are continuously tweaked as each new verified data point comes in. In step 207, the system takes the raw results of the AI analysis (for instance, the pollutant concentration map from step 205) and generates visualizations and reports. The visualization could be a live heatmap overlaying pollutant levels on a geographic map or on the camera's field of view, updating with each new analysis cycle. Reports could include metrics like the highest pollutant concentration detected in the last hour, the locations of any hotspots (areas consistently showing high pollution), and trends compared to previous days. If certain thresholds are exceeded, step 207 can also include generating alerts or warning messages as part of the reporting. For example, if the urban PM_{2.5} level in a downtown area crosses the “unhealthy” threshold, the system might flash a warning on the dashboard, send out an email/text alert to city health officials, or even trigger public warning systems. Step 208 acknowledges that the system itself requires oversight to ensure it continues to function correctly and accurately over time. This involves routine checks and maintenance activities which may be automated or performed by technicians. Additionally, step 208 can cover the security monitoring of the system ensuring data is securely transmitted and stored.

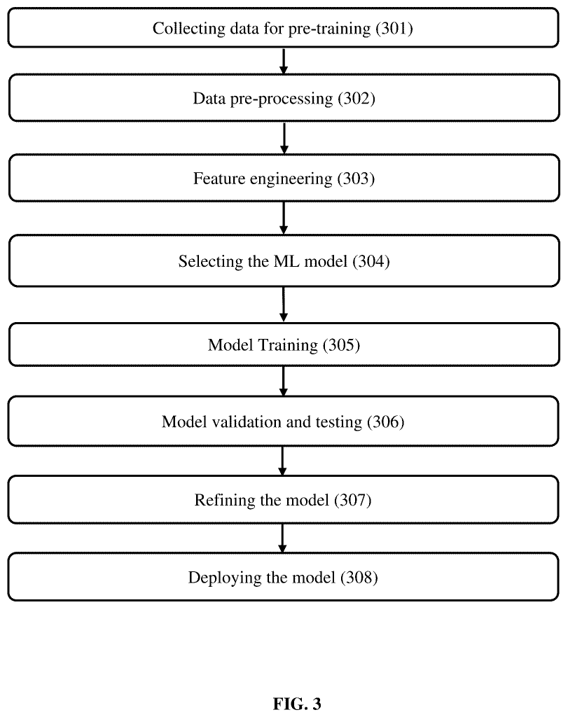

FIG. 3 illustrates a method for generating pre-trained model for image-based air pollution monitoring, according to one embodiment herein. The method comprises: training and testing data collection (301), data pre-processing (302), feature engineering (303), selecting the ml model (304), model training (305), model validation and testing (306), refining the model (307), and deploying the model (308).

FIG. 4 illustrates a system to produce a pollutant concentration distribution map from image data. The image capturing unit 401 gathers images across several spectral bands, for example, UV, NIR, and visible imagery.

In some embodiments, the system can be expanded to incorporate multiple imaging devices and viewpoints, offering wide coverage and perspective on the monitored area. For example, several image capturing units could be deployed in different locations or mounted on multiple drones, each capturing images of the environment from distinct angles.

In an embodiment, reference measurements 402 are one or more physical sensors that measure pollutant concentration directly (for example, a gas analyzer or particulate sensor stationed in the area being imaged) and/or other environmental parameters. The reference measurements 402 are associated in time and location with the images from the image capturing unit 401. Each reference measurement is linked to an image (or pixel of an image) taken at the same moment and place. For instance, if an image capturing unit 401 takes an image at 12:00:00 PM of a factory plume, the system looks for sensor readings (402) at that same time (12:00:00 PM) and from a sensor positioned either at the factory or at least within the plume's vicinity in the image. The coordinate (y) represents spatial coordinates such as GPS location or a specific region in the image that corresponds to the sensor's location. By doing this timestamp and location matching, the system effectively pairs what the camera “sees” with what the sensor “reads,” creating labeled data points. For example, the reference measurement 402 is a ground-based SO₂ sensor reading 0.1 ppm at a certain location and moment, the system knows that the portion of the UV image 401 corresponding to that location at that time is associated with 0.1 ppm of SO₂. The matched image and sensor data feed into the formation of a training dataset 404. In FIG. 4, training dataset 404 is the collection of multi-spectral image data (UV, NIR, Visible) annotated with reference measurements. Essentially, the training dataset 404 is used to train or update the AI model. Initially, the training dataset is continuously expanded with new data points as the system runs (particularly as the system gets more reference inputs in the field).

In an embodiment, a processing unit 403 is communicatively coupled to the image capturing unit 401 such that, the processing unit takes in or receives the live image data from the image capturing unit 401 and, using the trained AI model, generates a pollutant concentration distribution map as output. The communicative coupling is achieved using, for example, networking and communications techniques known to those having ordinary skill in the art. In some embodiments, the communicative coupling is achieved using wired networking or communication techniques. In other embodiments, the communicative coupling is achieved using wireless networking or communication techniques. Internally, the processing might involve two phases: a training/calibration phase and an inference phase. During the training phase, the processing unit 403 uses the training dataset 404 to adjust the AI model's parameters. Once the model is trained and validated, the processing unit 403 switches to inference mode, where it processes new images from 401. For each incoming image frame, the AI model predicts pollutant concentrations for different parts of the image. The result is typically a two-dimensional field that aligns with the image's perspective or geographic projection, indicating how pollution concentration varies across the field of view. Additionally, beyond just producing the map, the processing unit analyzes the map to derive insights, for example, detecting the location of peak concentration (which indicate the source of emissions). So, as part of creating the distribution map, the processing unit highlights a particular spot as the likely origin of the pollutant if it consistently sees the highest values there. The map can also be used to observe how pollution moves over time (if sequential maps show the plume drifting, etc.), enabling temporal tracking of pollution events.

According to an embodiment, the processing unit 403 is capable of integrating inputs from multiple image capturing units to create a composite pollution map covering a wider region or providing a cross-validated view of the same pollutant plume from different perspectives. By analyzing overlapping fields of view, the system can improve the accuracy of pollutant localization, if the same high concentration region is detected by two different cameras from different angles, the confidence in that detection is increased.

After the processing unit 403 computes the distribution map, it can send this data to a remote server 405. The remote server 405 could be a cloud-based component where further data aggregation, higher-level analysis, or longer-term storage is handled.

In an embodiment, through a user interface, an operator or environmental analyst can see, in real time, where pollutant levels are elevated and how they are spreading. The system can highlight particular areas of concern; for instance, it can automatically identify an emission source by finding a local maximum in the concentration distribution. If one region of the heatmap consistently shows the highest intensity of a pollutant, the software can flag that region (e.g., drawing a marker or bounding box on the display) as a likely source of emissions that may warrant investigation or mitigation. The pollutant concentration map is updated continuously or at short intervals (e.g., each time a new image is processed, which could be multiple times per minute), which enables the visualization to show changes over time. A time sequence of these maps can reveal the movement of a pollution plume or the accumulation and dissipation of pollutants. By analyzing the temporal sequence, the system can track trends in pollutant levels, for example, it can determine if a particular area's pollutant concentration is steadily rising over the past several minutes or hours. Detecting such an increasing trend early allows the system to alert users to potential issues (such as an industrial process gradually emitting more pollutants) even before absolute concentration thresholds are crossed.

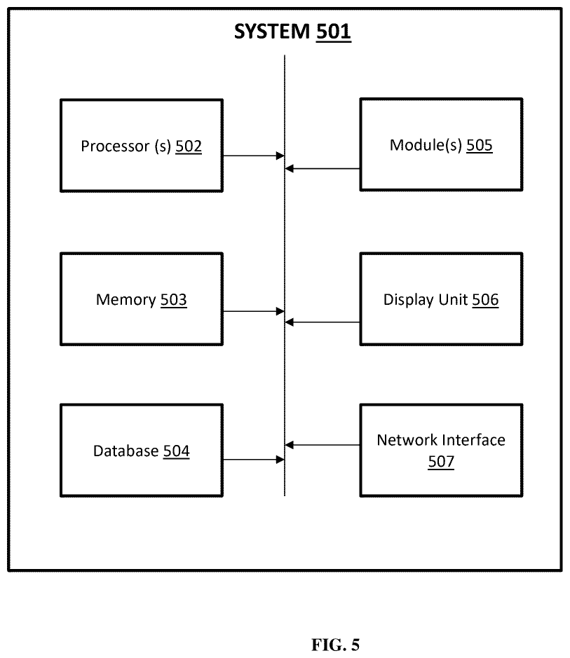

FIG. 5 illustrates a general block diagram of the system, according to an embodiment of the present disclosure.

In an example, the processor(s) 502 may be a single processing unit or a number of units, all of which could include multiple computing units. The processor(s) 502 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor(s) 502 is configured to fetch and execute computer-readable instructions and data stored in the memory 503.

The memory 503 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

In an example, the module(s), engine(s), and/or unit(s) 505 may include a program, a subroutine, a portion of a program, a software component or a hardware component capable of performing a stated task or function. As used herein, the module(s), engine(s), and/or unit(s) may be implemented on a hardware component such as a server independently of other modules, or a module can exist with other modules on the same server, or within the same program. The module(s), engine(s), and/or unit(s) 505 may be implemented on a hardware component such as processor one or more microprocessors, microcomputers, microcontrollers, digital signal processors, central processing units, state machines, logic circuitries, and/or any devices that manipulate signals based on operational instructions. The module(s), engine(s), and/or unit(s) 505 when executed by the processor(s) 502 may be configured to perform any of the described functionalities. In an alternate embodiment, the functions of the aforesaid modules may be performed by the processor(s) 502.

As a further example, the database 504 may be implemented with integrated hardware and software. The hardware may include a hardware disk controller with programmable search capabilities or a software system running on general-purpose hardware. Examples of databases are but are not limited to, in-memory databases, cloud databases, distributed databases, embedded databases, and the like. The database amongst other things, serves as a repository for storing data processed, received, and generated by one or more of the processor(s) 502, and the modules/engines/units 505.

The modules/engines/units 505 may be implemented with an AI module that may include a plurality of neural network layers. Examples of neural networks include, but are not limited to, a convolutional neural network (CNN), a deep neural network (DNN), a recurrent neural network (RNN), a Restricted Boltzmann Machine (RBM). The learning technique is a method for training a predetermined target device using a plurality of learning data to cause, allow, or control the target device to make a determination or prediction. Examples of the learning techniques include, but are not limited to, a supervised learning, unsupervised learning, a semi-supervised learning, or reinforcement learning. At least one of a plurality of CNN, DNN, RNN, RMB models and the like may be implemented to thereby achieve execution of the present subject matter's mechanism through an AI model. A function associated with the AI model may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or the artificial intelligence (AI) model stored in the non-volatile memory and the volatile memory. The predefined operating rule or artificial intelligence model is provided through training or learning.

As an example, the display unit 506 includes a computer monitor, a touch screen, an output device capable of displaying the graphics, and the like. The display unit is configured to display visual output on desktops, laptops, and workstations. The display unit may come in different sizes, resolutions, and types (such as LCD, LED, or OLED).

As a further example, the network interface 507 is configured to provide and establish communication with any electronic device via a public network, private network, or any suitable wired or wireless communication technology.

The figures of the disclosure are provided to illustrate some examples of the invention described. The figures are not to limit the scope of the depicted embodiments of the appended claims. Aspects of the disclosure are described herein with reference to the invention to example embodiments for illustration. It should be understood that specific details, relationships, and methods are set forth to provide a full understanding of the example embodiments. One of ordinary skills in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with a software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages include, but are not limited to, a macro language, a shell or command language, a job control language, a scripting language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system for image-based air pollution monitoring, the system comprising:
an image capturing unit, wherein the image capturing unit captures one or more images of a field of view in one or more spectral bands; and
a processing unit communicatively coupled to the image capturing unit, further wherein:
the processing unit comprises one or more processors and a memory storing a trained artificial intelligence (AI) model,
the processing unit:
receives the captured one or more images, and
determines, based on the captured one or more images and using the trained AI model, a pollutant concentration distribution map of the field of view.

2. The system of claim 1, wherein:
the AI model is trained using training data generated by synchronizing the captured one or more images with reference measurements obtained from one or more reference sensors, and
after the training, the pollutant concentration distribution map is determined based solely on the captured one or more images.

3. The system of claim 2, wherein the reference sensors comprises one or more of a ground-based sensor, an electrochemical sensor, a meteorological sensor, or a satellite-based remote sensing source.

4. The system of claim 1, wherein the image capturing unit captures single-band, multispectral, or hyperspectral images in one or more of the ultraviolet, visible, or near-infrared spectral ranges.

5. The system of claim 1, wherein the image capturing unit comprises at least one of a fixed camera, a movable camera, or a drone-mounted camera.

6. The system of claim 1, wherein the processing unit generates a heatmap representation of the pollutant concentration distribution map and identifies an emission source by detecting a local maximum of concentration in the heatmap representation.

7. The system of claim 1, wherein the processing unit performs image preprocessing comprising at least one of brightness normalization, motion compensation, haze reduction, or focus quality screening prior to determining the pollutant concentration distribution map.

8. The system of claim 1, further comprising a communication interface to transmit the pollutant concentration distribution map to a remote service for:
storage or visualization, or
to trigger an alert when a pollutant concentration threshold is exceeded.

9. The system of claim 1, wherein the pollutant concentration distribution map comprises concentration values of at least one atmospheric contaminant, wherein the at least one atmospheric contaminant comprises gaseous species and particulate matter, and the atmospheric contaminant comprises sulfur oxides (SOₓ), nitrogen oxides (NOx), ozone (O₃), carbon monoxide (CO), carbon dioxide (CO₂), volatile organic compounds (VOCs), hydrogen sulfide (H₂S), ammonia (NH₃) and particulate matter (PM), and mixtures thereof.

10. The system of claim 3, wherein the AI model is further trainable to determine concentrations of additional pollutants by retraining using training data formed by synchronizing captured images to corresponding reference measurements of the additional pollutants.

11. The system of claim 1, wherein the pollutant concentration distribution map is continuously updated in real time as new images are captured.

12. The system of claim 1, wherein the processing unit integrates image data from a plurality of spectral bands to determine the pollutant concentration distribution map.

13. The system of claim 2, wherein the reference sensors provide meteorological parameters including at least one of temperature, humidity, pressure, wind speed, or wind direction associated in time and location with the captured images.

14. The system of claim 1, wherein the processing unit tracks temporal changes across successive pollutant concentration distribution maps to detect an increasing pollutant concentration trend.

15. The system of claim 1, further comprising integrating images from a plurality of cameras providing different viewpoints prior to determining the pollutant concentration distribution map.

16. A method for image-based air pollution monitoring, comprising:
capturing one or more images of a field of view in one or more spectral bands; and
determining, based on the captured images and using a trained artificial intelligence (AI) model, a pollutant concentration distribution map of the field of view.

17. The method of claim 16, further comprising:
obtaining reference measurements from one or more reference sensors corresponding in time and location to the captured one or more images; and
training the AI model using training data formed by synchronizing the captured images to the corresponding reference measurements.

18. The method of claim 15, further comprising identifying an emission source by locating a maximum concentration region in the pollutant concentration distribution map.

19. A non-transitory computer-readable medium storing instructions that, when executed by one or more processors, cause the processors to:
capture one or more images of a field of view in one or more spectral bands;
determine, based on the captured images and using a trained artificial intelligence (AI) model, a pollutant concentration distribution map of the field of view.

20. The system of claim 1, further comprising a user interface, wherein the user interface displays the pollutant concentration distribution map.
